(19) United States
(12) Patent Application Publication
(10) Pub. No.: US 2009/0095825 A1
(43) Pub. Date: Apr. 16, 2009

(54) DISPENSER NOZZLE HAVING DIFFERENTIAL HARDNESS

(75) Inventors: Mani Ahmadi, Oceanside, CA (US); Erik A. Fiske, Carlsbad, CA (US)

Correspondence Address: WOOD, HERRON & EVANS, LLP (NORDSON), 2700 CAREW TOWER, 441 VINE STREET, CINCINNATI, OH, 45202, US

(73) Assignee: NORDSON CORPORATION, Westlake, OH (US)

(21) Appl. No.: 11/870,936

(22) Filed: Oct. 11, 2007

(51) Int. Cl. B05B 1/30; A62C 37/20; A62C 31/02

(52) U.S. Cl. 239/583; 239/562; 239/601; 239/570; 222/504

(57) ABSTRACT

A jet dispenser includes a fluid chamber body that includes a fluid chamber. A nozzle assembly is removably coupled to the fluid chamber body. The nozzle assembly includes a hub and an insert. The hub cooperates with the fluid chamber body to form a portion of the fluid chamber. A valve member is movably disposed within the fluid chamber. The insert is positioned at least partially within the hub. The insert includes a valve seat, a discharge passage, and an exit orifice at a distal end of the discharge passage. The valve seat is harder than the hub. The valve member selectively contacts the valve seat to dispense droplets of viscous material from the exit orifice.

### FIELD OF THE INVENTION

The present invention generally relates to viscous material dispensing apparatuses, and more particularly to a non-contact jet dispenser for dispensing discrete amounts of viscous material to a substrate.

### BACKGROUND OF THE INVENTION

Dispensing systems have become an integral part of the electronics manufacturing process for depositing underfill, encapsulants, solder fluxes, surface mount adhesives, conformal coatings, and other materials onto a substrate, such as a printed circuit board. Each dispensing system used in the electronics manufacturing process has a particular dispensing characteristic that is determined in large measure by the desired dispense pattern on the substrate, the flow rate and/or viscosity of the dispensed material, and the desired electronic component assembly throughput through the dispensing system.

For example, in the assembly of ball grid arrays (BGAs) and other electronic components onto a ceramic or flame-retardant, woven-glass epoxy (FR-4) substrate, the component must be soldered onto the substrate to form the necessary electrical interconnections. As each component occupies a predetermined area on the substrate, the dispensing system must have the capability to dispense liquid or viscous material in a controlled manner within the selected component areas. Typically, the dispenser is mounted on a movable platform to provide automated and accurate movement of the dispenser in three dimensions relative to the substrate with the aid of a machine vision system. Alternatively, the dispenser may be fixed in position and the substrate moved to direct placement of material thereon.

It is often necessary or at least desirable to underfill devices on a substrate within specific areas associated with each device. To provide this capability, dispensers have been developed that use filled syringes or reservoirs of underfill material, and dispensing valves to dispense droplets of underfill material onto the substrate in a controlled manner, with up to 25,000 to 40,000 dots or droplets of material per hour for a typical dispenser platform. These dispensers, known as “dot jetting” or “jet” dispensers, are programmed to dispense an array of viscous liquid or material droplets within each selected area. Often it is critical to provide small fillets of underfill or encapsulants in a controlled area so that the underfill material does not contact die surfaces, adjacent wire bonds, or other components.

Droplets are generally dispensed via a nozzle toward the substrate. The dimensions of the nozzle, at least in part, influence the volume of the droplet ejected from the nozzle. Control of the droplet-to-droplet volume is critical to the quality and cost of the overall process. However, long-term variation in droplet volume often occurs due to wear within the dispensing system, particularly within the nozzle which is in continuous and direct contact with materials while at elevated temperatures and pressures. In addition, actuation of one or more mechanical members in contact with the nozzle may accelerate wear at these locations. For example, a valve member may contact a valve seat within the dispenser to eject material from the nozzle. This contact may be repeated for each droplet formed. Cyclic contact of the valve member against the valve seat results in rapid deterioration of the valve seat and surrounding surfaces. Once the droplet volume variation reaches the limits established by quality control, the nozzle is replaced. Thus, to reduce costs and improve droplet volume consistency, the nozzles should resist wear while in use.

A need therefore exists for a dispenser, particularly a nozzle, that overcomes the limitations associated with current droplet volume variability due to nozzle wear while keeping the nozzle manufacturing cost at a minimum.

### SUMMARY

In one illustrative embodiment, a jet dispenser is provided comprising a dispenser body adapted to be coupled to a source of viscous material. The dispenser body includes a fluid chamber. A nozzle assembly is removably coupled to the dispenser body. The nozzle assembly includes a hub and an insert. The hub cooperates with the dispenser body to form a portion of the fluid chamber. The hub is formed from a material having a first hardness. The insert is positioned at least partially within the hub. The insert includes a valve seat, a discharge passage, and an exit orifice at a distal end of the discharge passage. In one embodiment, the valve seat has a second hardness greater than the first hardness.

Furthermore, a valve member is movably disposed in the fluid chamber for selective contact with the valve seat. A valve driver is operably coupled to the valve member and is adapted to selectively move the valve member out of and into contact with the valve seat. The valve member imparts sufficient momentum to viscous material in the insert upon contact with the valve seat to dispense droplets of viscous material from the exit orifice.

In another embodiment, the hub and the insert are discrete components with the insert made of a material that is harder than the hub material. In one embodiment, the hub comprises a stainless steel and the insert comprises a ceramic, for example, alumina or aluminum oxide. The insert is rigidly fixed within the stainless steel hub.

These and other features, advantages, and objectives of the invention will become more readily apparent to those of ordinary skill in the art upon review of the following detailed description of the exemplary embodiments, taken in conjunction with the accompanying drawings.

### BRIEF DESCRIPTION OF THE DRAWINGS

FIG. 1 is a cross-sectioned elevation view of an exemplary jet dispenser;

FIG. 2 is an enlarged detail of the jet dispenser of FIG. 1;

FIG. 3 is an enlarged detail of the jet dispenser illustrating the nozzle assembly;

FIG. 4 is a perspective view of one embodiment of the nozzle assembly; and

FIG. 4A is a cross-sectional view of the nozzle assembly of FIG. 4.

### DETAILED DESCRIPTION

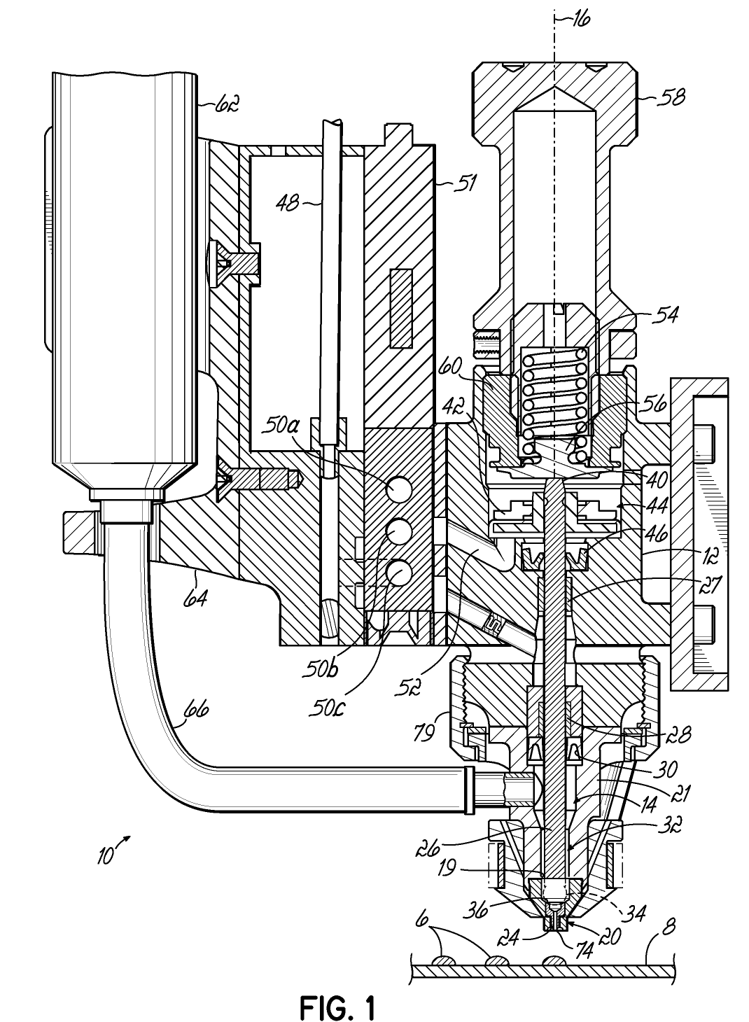

FIG. 1 depicts an exemplary jet dispenser 10 configured to form droplets 6 of material and project them toward a substrate 8. Generally, the viscous material may be any highly-viscous material including, but not limited to, solder flux, solder paste, adhesives, solder mask, thermal compounds, oil, encapsulants, potting compounds, inks, silicones, or visco-elastic fluids. In the embodiment shown, substrate 8 is moved in one direction to control the placement of droplets 6 on the substrate 8. It will be appreciated, however, that the jet dispenser 10 may alternatively be moved relative to the substrate 8. Examples of a jet dispenser is shown and described in co-pending PCT Application US 2004/020247 (Publication No. WO 2005/009627) filed Jun. 25, 2004, although it will be recognized that various other types of jet dispensers could be used as well, and the principles as disclosed herein are not limited to use with the particular jet dispenser illustrated and described. PCT Application US 2004/020247 is commonly owned by the Assignee of the present application and is incorporated by reference herein in its entirety.

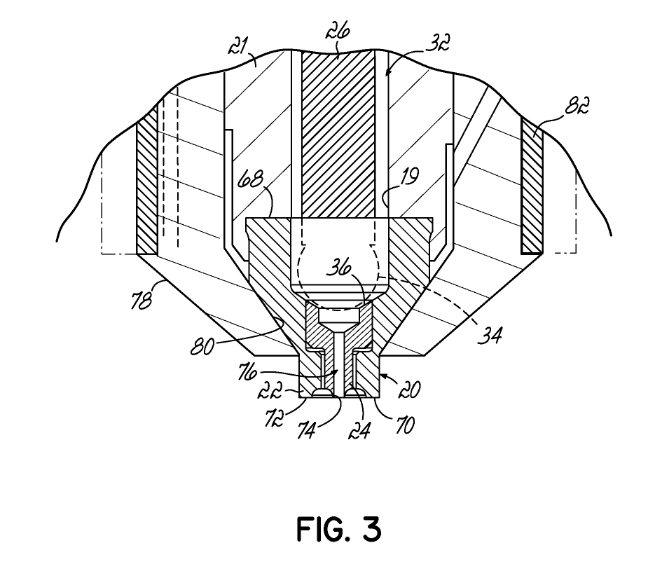

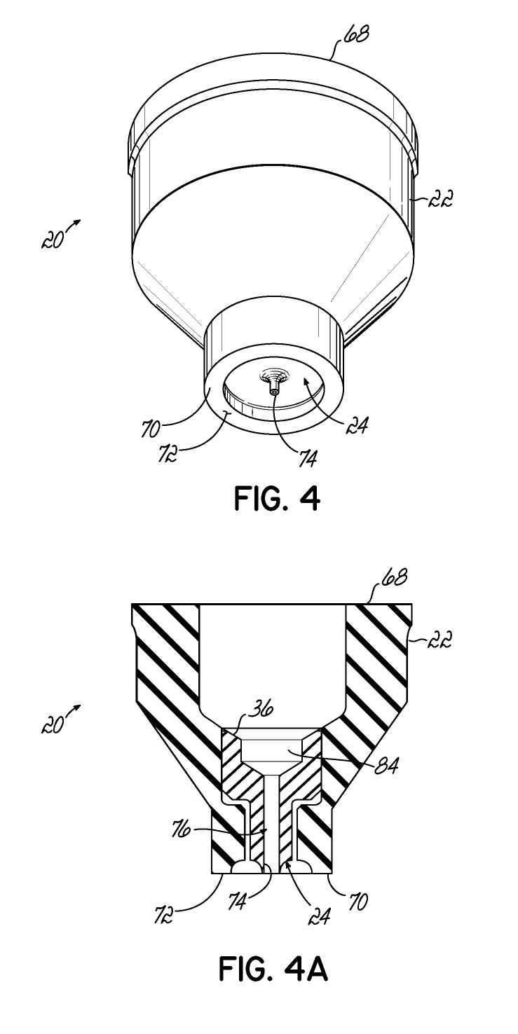

One embodiment of the jet dispenser 10 is depicted in FIG. 1. As shown, the jet dispenser 10 comprises a dispenser body 12 having an elongate bore or channel 14 formed therethrough and having a central axis 16 defined therealong. A nozzle assembly 20 removably attaches to the fluid chamber body 21 at a channel outlet 19 of the channel 14. As shown in FIGS. 3, 4, and 4A, the nozzle assembly 20 includes a hub 22 and an insert 24. As will be described in more detail later, in one embodiment of the nozzle assembly 20, the insert 24 is made of a material having a hardness that is greater than the hardness of the material from which the hub 22 is made.

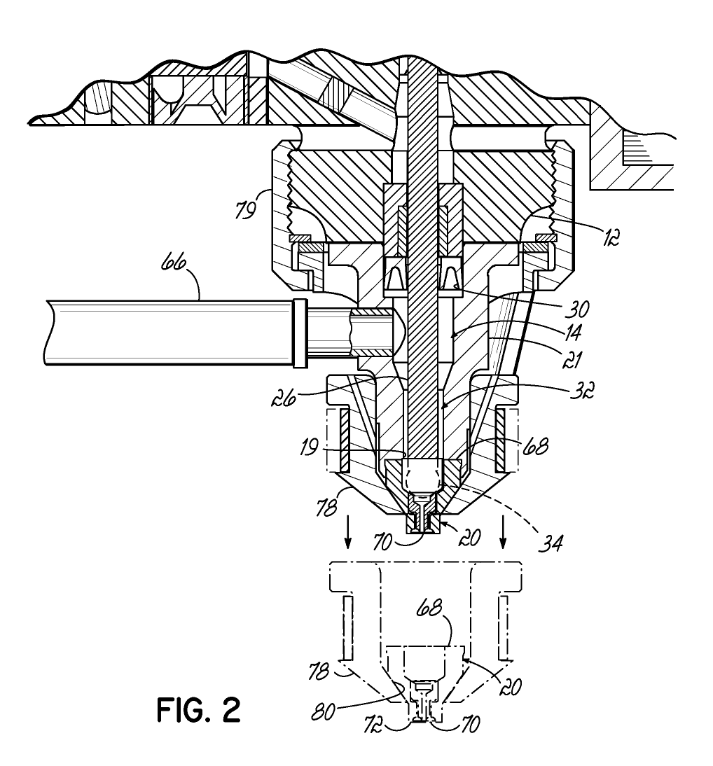

With reference now to FIGS. 1 and 2, a generally elongate valve stem or valve member 26 is mounted for reciprocating movement within the channel 14. The valve member 26 is supported for sliding movement within the channel 14 by bushings 27, 28 (shown in FIG. 1). A seal 30 disposed in the channel 14 partially defines a fluid chamber 32 proximate the channel outlet 19. As is shown most clearly in FIG. 3, the valve member 26 is biased in a direction toward the channel outlet 19 such that a first end 34 of the valve member 26 normally contacts a valve seat 36 formed of the insert 24. In another embodiment, the hub 22 is made of a material having a first hardness and the valve seat 36 has a second hardness greater than the first hardness. By way of example only, following machining thereof, the valve seat 36 may be hardened by subsequent heat treatment or work hardening; plated or coated with subsequent processing, for example, chrome plating or HVOF (High Velocity Oxygen Fuel) spray coating containing one or more metallic carbides, PaCVD (Plasma assisted Chemical Vapor Deposition), or modified by any one of a number of surface treatment techniques, such as, ion implantation or diffusion processes.

Continuing with reference to FIG. 1, a second end 40 of the valve member 26 is coupled to an air piston 42 that is slidably movable within a piston cavity 44 formed in the dispenser body 12. A seal 46 is disposed between the piston cavity 44 and channel 14 and permits sliding movement of the valve member 26 therethrough while sealing the piston cavity 44 from the fluid chamber 32. High pressure air supplied from an air source (not shown) via conduit 48 is selectively directed by a solenoid valve 51 to and from the piston cavity 44 through ports 50a, 50b, 50c and air passage 52 to rapidly move the air piston 42, and thus the valve member 26, as known in the art. A compression spring 54 acting through a load button 56 contacts the second end 40 of the valve member 26 and biases the valve member 26 in a direction toward the channel outlet 19. The amount of preload applied to the spring 54 can be adjusted by a rotatable knob 58 that is threadably coupled to a sleeve 60 that contains the spring 54.

The jet dispenser 10 may be supplied with pressurized, viscous material from a syringe-type supply device 62 that is supported by a syringe holder 64 mounted to the dispenser body 12. While the jet dispenser 10 is shown and described herein as having a syringe-type supply 62, it will be appreciated that the jet dispenser 10 may alternatively be coupled to various other sources of viscous material. The syringe-type supply 62 is in fluid communication with the fluid chamber 32 via a fluid conduit 66 that supplies liquid material under relatively low pressure from the supply 62 to the fluid chamber 32. Viscous material from the syringe-type supply 62 enters and fills the fluid chamber 32. With the valve member 26 normally contacting the valve seat 36, as depicted in FIG. 3, the viscous material is blocked from exiting the jet dispenser 10 through the nozzle assembly 20.

With continued reference to FIG. 2, the nozzle assembly 20 is removably coupled to the fluid chamber body 21, adjacent the channel outlet 19 such that the nozzle assembly 20 forms a portion of the fluid chamber 32. In the embodiment shown, the nozzle assembly 20 has a first side 68 adapted to sealingly engage the fluid chamber body 21, adjacent the channel outlet 19, and a second side 70, having a dispensing surface 72 (shown most clearly in FIGS. 3 and 4A).

As is most clearly shown in FIG. 3, an exit orifice 74 is formed on the dispensing surface 72. The exit orifice 74 is in fluid communication with the channel outlet 19 via a discharge passage 76 when the valve member 26 is in a retracted position. Thus, material may be jetted from the fluid chamber 32 through the discharge passage 76 and out of the jet dispenser 10 via the exit orifice 74 as the valve member 26 strokes from a retracted position into a contact position with the valve seat 36, as shown. In one embodiment, the discharge passage 76, the exit orifice 74, and other surfaces within the insert 24 are hardened in a similar manner as that described for the valve seat 36 above. These surfaces thereby resist abrasive wear during operation of the jet dispenser 10.

In one embodiment, as shown in FIGS. 2 and 3, the nozzle assembly 20 is removably secured to the fluid chamber body 21 by a removable heater body 78. The heater body 78 is attached to the dispenser body 12 via a threaded collar assembly 79 having a set of lift fingers (not shown) that engage an upper portion of the heater body 78. In the embodiment shown, the removable heater body 78 is a generally cupped-shaped member having a flanged for engagement with the lift fingers that project from the collar assembly 79. The collar assembly 79 contains internal screw threads formed along the inner side walls for threadably engaging corresponding external screw threads formed on the dispenser body 12. A lower interior portion 80 of the removable heater body 78 is configured to engage the nozzle assembly 20 such that the first side 68 of the nozzle assembly 20 may be clamped tightly against the fluid chamber body 21 adjacent the channel outlet 19.

In another embodiment and with reference to FIG. 3, a heating element 82 is in thermal contact with the removable heater body 78. As is known in the art, the heating element 82 may be a flexible thermal foil resistance heater. The heating element 82 supplies heat to a portion of the jet dispenser 10 which transfers heat to the viscous material. As is known in the art, the viscous material may have a viscosity that is a function of temperature. Therefore, control of the viscous material temperature may be one factor in controlling the volume of the droplets 6 jetted from the exit orifice 74.

As shown in FIGS. 1, 2, and 3, the nozzle assembly 20 may have a generally frustoconical shape that tapers in the direction of the dispensing surface 72, and the lower interior portion 80 of the removable heater body 78 has sloped sidewalls that correspond to the taper of the nozzle assembly 20 to facilitate a fluid tight seal between the nozzle assembly 20 and the fluid chamber body 21. While the nozzle assembly 20 is shown and described herein as being removably coupled to the fluid chamber body 21 by the removable heater body 78, it will be recognized that various other methods for securing the nozzle assembly 20 to the fluid chamber body 21 may alternatively be used.

As depicted in FIGS. 3 and 4A, the discharge passage 76 is formed through the insert 24. To dispense material, the valve member 26 of FIG. 3 is retracted away from the valve seat 36, and relatively low pressure applied to the viscous material in the syringe-type supply 62 (illustrated in FIG. 1) causes the viscous material to flow through the fluid conduit 66 and into the fluid chamber 32, filling the volume previously occupied by the valve member 26. In operation, material also resides in the discharge passage 76. In one embodiment, the pressure applied to syringe-type supply 62 of FIG. 1 is only sufficient to fill the void created by retracting the valve member 26. That is, the viscous material is not prematurely forced from the exit orifice 74 by application of the pressure. It will be appreciated that the interior surfaces of the nozzle assembly 20 (i.e., the interior of the hub 22 and the interior surface of the insert 24, including the valve seat 36, the discharge passage 76, and the exit orifice 74) are in direct and continuous contact with the viscous material. Consequently, the interior surfaces of the nozzle assembly 20 must be abrasion resistant to the contact with the viscous material under pressure and, possibly, at elevated temperatures.

In operation, and with reference once again to the embodiment shown in FIG. 1, the valve member 26 is moved by actuating the solenoid valve 51 to supply high pressure air to the piston cavity 44, as discussed above, to overcome the bias force of the spring 54. The solenoid 51 is then actuated to discharge air from the piston cavity 44 and the valve member 26 is rapidly moved back into contact with the valve seat 36 by the bias force of the spring 54. This rapid movement, and the subsequent rapid impact of the valve member 26 against the valve seat 36, imparts momentum to the viscous material then residing in the insert 24. The momentum imparted to the material as the valve member 26 impacts the valve seat 36 causes the droplet 6 of material to be jetted from the exit orifice 74. In addition, the impact of the valve member 26 onto the valve seat 36 causes impact stresses within and abrasion of the insert 24. When the solenoid 51 is actuated in rapid succession, the resulting cyclic impact of the valve member 26 onto the valve seat 36 jets droplets 6 from the exit orifice 74, as well as magnifies the impact stresses and abrasion on the insert 24, particularly within the valve seat 36 and surrounding material.

As previously described, in accordance with the principles disclosed herein and with reference now to FIGS. 3, 4 and 4A, the nozzle assembly 20 includes the insert 24 having the valve seat 36 having a hardness which is greater than the material of the hub 22. The valve seat 36 thus withstands prolonged exposure to abrasive conditions found within the jet dispenser 10 due to direct and continuous contact of the valve seat 36 with the viscous material combined with the cyclic impact of the valve member 26. For example, in one embodiment, the valve seat 36 is coated with a material having the previously described properties or, alternatively, the insert 24 may be hardened by methods known in the art to improve the hardness of the interior contact surfaces of the insert 24, including the valve seat 36.

In another embodiment, as shown most clearly in FIG. 4A, the hub 22 and the insert 24 are discrete components. It will be appreciated then that the hub 22 and the insert 24 are assembled prior to being coupled to the fluid chamber body 21, previously described. The insert 24 may be rigidly fixed concentrically within the hub 22. In one embodiment, once the insert 24 is assembled within the hub 22, the discrete components are not easily separable without destroying one or both of the hub 22 and the insert 24. For example, the insert 24 may be rigidly fixed within the hub 22 by press fitting or by gluing the two components together with an adhesive.

As is known in the art, nozzle components may measure only a few millimeters in any dimension. In contrast to the prior art, therefore, rigidly fixing the insert 24 within the hub 22 provides a nozzle assembly 20 that is more easily handled for coupling to the fluid chamber body 21 during maintenance or cleaning operations or during assembly with the fluid chamber body 21 as depicted in FIG. 2. Furthermore, when the hub 22 and the insert 24 are assembled together and then removably coupled to the fluid chamber body 21, the valve seat 36 aligns with the valve member 26 such that substantially uniform contact occurs between the valve member 26 and the valve seat 36. One skilled in the art will observe that the discharge passage 76 may also substantially coaxially align with the central axis 16 (illustrated only in FIG. 1) of the valve member 26.

In one embodiment, the insert 24 comprises a ceramic material. By way of example, the ceramic material may be alumina or aluminum oxide (including sapphire), zirconia, tungsten carbide, or any one of a number of high hardness, abrasive resistant oxide or nonoxide ceramics that reduces deterioration of the valve seat 36, discharge passage 76, and exit orifice 74. As is known in the art, for example, an 85% alumina ceramic has a hardness of about 800-900 kgf/mm² Vickers Hardness with higher alumina content increasing the hardness. While machining ceramic material may be more difficult, the insert 24 made of a ceramic material generally lacks burrs associated with machining metals. As is known in the art, residual machining defects, such as burrs, disrupt or even destroy fluid flow. These defects may also capture viscous material and result in inconsistent droplet 6 formation as well as variable droplet volume. Thus, the insert 24, as described herein, includes the valve seat 36, the discharge passage 76, and the exit orifice 74 that may be substantially burr free. In another embodiment, the insert 24 may comprise a hardenable steel, for example, a tool steel. As is known in the art, such steel may be treated to surface harden to around 700 kgf/mm² Vickers Hardness or more depending on the type of tool steel and treatment selected (e.g., oil, air, or water quench).

According to the principles described herein, the insert 24 extends the usable life of the nozzle assembly 20. Moreover, the insert 24 decreases short-term and long-term variability in the volume between multiple droplets 6 and consequently reduces viscous material consumption while simultaneously reducing downtime of the jet dispenser 10. The costs of the nozzle assembly 20 may be more than offset by the improved performance and cost savings due to the previously mentioned benefits of the insert 24 being made of a material harder than the hub 22.

In one embodiment, the hub 22 is a machinable material. However, the hub 22 is capable of withstanding any cyclic elastic shock waves generated by the impact of valve member 26 on the valve seat 36. In other words, the hub 22, as described herein, is durable or tough but sufficiently machinable. For example, the hub 22 may be made of one or more materials having a high modulus. Consequently, the hub 22 does not substantially elastically deform or disrupt material flow through the jet dispenser 10 when impacted by the valve member 26. Like the insert 24 previously described, the hub 22 is temperature resistant in those embodiments utilizing the heating element 82 to maintain the material within the nozzle assembly 20 at temperatures above ambient. In another embodiment, the hub 22 is made of a material that is heat conductive which facilitates temperature uniformity of the material within the nozzle assembly 20. By way of example, the hub 22 may comprise a high performance plastic (e.g. polyetheretherketone or PEEK), stainless steel, aluminum alloy, or other low cost machinable or moldable materials. In one embodiment, the hub 22 comprises stainless steel, such as a 300 series stainless steel. As is known in the art, annealed 300 series stainless steels have a hardness generally of around 150 kgf/mm² Vickers Hardness.

With reference to FIG. 4A, in yet another embodiment, a volume within the insert 24 as defined from the exit orifice 74 to the valve seat 36 is minimized. Thus, in one embodiment, the insert 24 is formed with a dispensing chamber 84 to facilitate jetting of the droplet 6 from the exit orifice 74 of a controlled volume. As shown in FIG. 4A, the dispensing chamber 84 has a diameter that is greater than the diameter of the discharge passage 76.

While the present invention has been illustrated by the description of an embodiment thereof, and while the embodiment has been described in considerable detail, it is not intended to restrict or in any way limit the scope of the appended claims to such detail. Additional advantages and modifications will readily appear to those skilled in the art. The various features disclosed herein may be used alone or in any combination with each other or with other features, for example. The invention in its broader aspects is therefore not limited to the specific details, representative apparatus and method and illustrative examples shown and described. Accordingly, departures may be made from such details without departing from the scope or spirit of the general inventive concept.

1. A jet dispenser for dispensing viscous materials, comprising:
a fluid chamber body adapted to be coupled to a source of viscous material, said fluid chamber body including a fluid chamber;
a nozzle assembly removably coupled to said fluid chamber body, said nozzle assembly including a hub and an insert, wherein
(i) said hub cooperates with said fluid chamber body to form a portion of said fluid chamber, said hub formed from a material having a first hardness; and
(ii) said insert positioned at least partially within said hub, said insert including a valve seat, a discharge passage, and an exit orifice at a distal end of said discharge passage, wherein said valve seat is formed from a material having a second hardness greater than said first hardness;
a valve member movably disposed in said fluid chamber for selective contact with said valve seat; and
a valve driver operably coupled to said valve member and adapted to selectively move said valve member out of and into contact with said valve seat, whereby said valve member imparts sufficient momentum to viscous material in said insert upon contact with said valve seat to dispense viscous material from said exit orifice.

2. The jet dispenser of claim 1 wherein said hub and said insert are discrete components, and said insert is rigidly fixed concentrically within said hub such that when said hub is coupled to said fluid chamber body, said discharge passage is substantially coaxially aligned with said valve member.

3. The jet dispenser of claim 2 wherein said insert comprises at least one of alumina, zirconia, or tungsten carbide or combinations thereof.

4. The jet dispenser of claim 2 wherein said hub comprises at least one of a stainless steel, aluminum, polyetheretherketone (PEEK) or combinations thereof.

5. The jet dispenser of claim 1 wherein said insert further includes a dispensing chamber positioned between said valve seat and said exit orifice, wherein said dispensing chamber has at least one dimension greater than said diameter of said discharge passage and is adapted to facilitate dispensing controlled amounts of viscous material from said exit orifice.

6. The jet dispenser of claim 1 wherein said second hardness is at least approximately 150 kgf/mm² Vickers Hardness.

7. The jet dispenser of claim 1 wherein said second hardness is at least approximately 700 kgf/mm² Vickers Hardness.

8. The jet dispenser of claim 1 wherein said second hardness is at least 800 kgf/mm² Vickers Hardness.

9. A nozzle assembly for assembly with a jet dispenser adapted to dispense viscous material, the jet dispenser including a fluid chamber body adapted to be coupled to a source of viscous material, wherein the fluid chamber body includes a fluid chamber, and the jet dispenser includes a valve member movably disposed within the fluid chamber, said nozzle assembly comprising:
a hub adapted to cooperate with the fluid chamber body, said hub forming a portion of the fluid chamber, said hub formed from a material having a first hardness; and
an insert concentrically positioned at least partially within said hub, said insert including a valve seat, a discharge passage, and an exit orifice formed at a distal end thereof, wherein said valve seat is formed from a material having a second hardness greater than said first hardness and said discharge passage and said exit orifice are in selective fluid communication with the fluid chamber by selective engagement of the valve member with said valve seat.

10. The nozzle assembly of claim 9 wherein said hub and said insert are discrete components and said insert is rigidly fixed concentrically within said hub such that when said hub is coupled to the fluid chamber body, said discharge passage is substantially coaxially aligned with the valve member.

11. The nozzle assembly of claim 10 wherein said insert comprises at least one of alumina, zirconia, or tungsten carbide or combinations thereof.

12. The nozzle assembly of claim 10 wherein said hub comprises at least one of a stainless steel, aluminum, polyetheretherketone (PEEK) or combinations thereof.

13. The nozzle assembly of claim 9 wherein said insert further includes a dispensing chamber positioned between said valve seat and said exit orifice, wherein said dispensing chamber has at least one dimension greater than said diameter of said discharge passage and is adapted to facilitate dispensing controlled amounts of viscous material from said exit orifice.

14. The nozzle assembly of claim 9 wherein said second hardness is at least approximately 150 kgf/mm² Vickers Hardness.

15. The nozzle assembly of claim 9 wherein said second hardness is at least approximately 700 kgf/mm² Vickers Hardness.

16. The nozzle assembly of claim 9 wherein said second hardness is at least 800 kgf/mm² Vickers Hardness.

17. A nozzle assembly for assembly with a jet dispenser adapted to dispense viscous material, the jet including a fluid chamber body adapted to be coupled to a source of viscous material, wherein the fluid chamber body includes a fluid chamber, and the jet dispenser includes a valve member movably disposed within the fluid chamber, said nozzle assembly comprising:
a stainless steel hub adapted to cooperate with the fluid chamber body, said stainless steel hub forming a portion of the fluid chamber; and
an alumina insert rigidly fixed within said stainless steel hub, said alumina insert including a valve seat, a discharge passage, an exit orifice formed at a distal end thereof, and a dispensing chamber positioned between said valve seat and said exit orifice, wherein said dispensing chamber has at least one dimension greater than a diameter of said discharge passage, and said discharge passage, said exit orifice, and said dispensing chamber are in selective fluid communication with the fluid chamber by selective engagement of the valve member with said valve seat.

18. A nozzle assembly comprising:
a hub from a material having a first hardness; and
an insert concentrically positioned at least partially within said hub, said insert including a valve seat, a discharge passage, and an exit orifice formed at a distal end thereof, wherein said valve seat is formed from a material having a second hardness greater than said first, wherein said hub and said insert are discrete components and said insert is rigidly fixed concentrically within said hub.

19. The nozzle assembly of claim 18 wherein said insert comprises at least one of alumina, zirconia, or tungsten carbide or combinations thereof and said hub comprises at least one of a stainless steel, aluminum, or polyetheretherketone (PEEK) or combinations thereof.

20. The nozzle assembly of claim 18 wherein said second hardness is at least approximately 150 kgf/mm² Vickers Hardness.

21. The nozzle assembly of claim 18 wherein said second hardness is at least approximately 700 kgf/mm² Vickers Hardness.

22. The nozzle assembly of claim 18 wherein said second hardness is at least 800 kgf/mm² Vickers Hardness.
